(19) United States
(12) Patent Application Publication
(10) Pub. No.: US 2020/0190355 A1
(43) Pub. Date: Jun. 18, 2020

(54) USE OF A LACQUER SYSTEM FOR COATING A LENS, METHOD OF COATING AN EDGE OF A LENS, AND LENS

(71) Applicant: Leica Camera AG, Wetzlar (DE)

(72) Inventors: Dirk Wunderlich, Haiger (DE); Stefan Best, Solms (DE); Andreas Diete, Solms (DE)

(21) Appl. No.: 16/717,293

(22) Filed: Dec. 17, 2019

(30) Foreign Application Priority Data
Dec. 17, 2018 (DE) 102018132471.5

(51) Int. Cl. C09D 163/04; C09D 133/12; G02B 1/115; G02B 1/14

(52) U.S. Cl. CPC C09D 163/04; C09D 133/12; C08K 2003/3045; G02B 1/14; G02B 1/115

(57) ABSTRACT

Disclosed is the use of a lacquer system for producing a lacquer edge coating on an edge of a lens, wherein-the lacquer system comprises at least one first component and one second component and configured to be hardened by irradiation with light of a wavelength in the range from 0.7 μm to 1.4 μm; wherein the first component comprises at least one resin, at least one diluent, and at least one filler, with the content of the at least one resin in the first component amounting to 20 to 65 wt. % of the first component, with the content of the diluent amounting to 5 to 70 wt. % of the first component, and the content of filler amounting to 2 wt. % of the first component; and wherein the second component comprises at least one crosslinking agent.

The present invention relates to a use of a lacquer system for coating a lens, to a method of coating an edge of a lens, and to a lens.

It is known to blacken the edge of lenses to avoid and reduce scattered light in a lens cylinder. It is necessary here that the blackened edge has a plurality of properties. The edge blackening thus has to have sufficient adhesion. Very good solvent resistance is likewise necessary to ensure that the edge blackening is not damaged on a further processing, for example when mounting the lenses, during which solvents may be used. It is furthermore necessary that the edge blackening has, in addition to the above-named properties, high UV resistance, high resistance to hot and cold temperatures and to temperature changes, and also to humid heat, artificial hand perspiration, cosmetic base substances, and salt.

With lacquering systems previously used to produce the edge blackening, a long drying time of approximately 48 hours at an elevated temperature and of a further 48 hours at room temperature is required after the application of the lacquer system to an edge of a lens until the aforesaid properties are achieved to a sufficient degree. The produced edge blackening only has sufficient stability to further process the lens after this long drying time. The production of the edge blackening of lenses causes high process costs due to the long drying time of the previously used lacquer systems. The long drying times and the high process times associated therewith can be due to the fact that the heat transfer by convection with air as the intermediate medium only has low efficiency.

There is therefore a need to produce edge blackening of lenses within such a short time that it has sufficient adhesion, very good solvent resistance, high UV resistance, high resistance to hot and cold temperatures, to temperature changes, and also to humid heat, artificial hand perspiration, cosmetic base substances, and salt.

This object is satisfied by the user of a lacquer system, by a method, and by a lens in accordance with the independent claims.

The present invention relates to the use of a lacquer system for producing a coating on an edge of a lens, wherein the lacquer system comprises at least one first component and one second component and can be hardened by irradiation with light of a wavelength of 0.7 μm to 1.4 μm; wherein the first component comprises at least one resin component selected from the group comprising epoxy resin, acrylic resin, and mixtures thereof, at least one diluent in the form of an organic solvent, and at least one or more fillers, with the content of the at least one epoxy resin and/or at least one acrylic resin in the first component amounting to 20 to 65 wt. % relative to the total weight of the first component, with the content of the diluent amounting to 5 to 70 wt. % relative to the total weight of the first component, and with the content of filler amounting to 2 wt. % or more relative to the total weigh of the first component; and wherein the second component comprises at least one crosslinking agent that is selected from the group comprising aliphatic isocyanates, aromatic isocyanates, compounds with amino groups, and mixtures thereof.

The present invention in addition relates to a method of coating an edge of a lens comprising step (A): Applying a lacquer system to an edge of the lens to be coated, wherein the lacquer system comprises at least one first component and one second component and can be hardened by irradiation with light of a wavelength in the range from 0.7 to 1.4 μm; wherein the first component comprises at least one resin component selected from the group comprising epoxy resin, acrylic resin, and mixtures thereof, at least one diluent in the form of an organic solvent, and at least one or more fillers, with the content of the at least one epoxy resin and/or at least one acrylic resin in the first component amounting to 20 to 65 wt. % relative to the total weight of the first component, with the content of the diluent amounting to 5 to 70 wt. % relative to the total weight of the first component, and with the content of filler amounting to 2 wt. % or more relative to the total weight; and wherein the second component comprises at least one crosslinking agent that is selected from the group comprising aliphatic isocyanates, aromatic isocyanates, compounds with amino groups, and mixtures thereof; and step (B): Hardening the lacquer system by irradiation with light at a wavelength in the range from 0.7 to 1.4 μm.

The present invention additionally also relates to a lens having a lacquer edge coating that can be obtained by the use in accordance with the invention of a lacquer system and/or that can be obtained by the method in accordance with the invention.

Lenses can be manufactured considerably less expensively than with conventional lacquer systems due to the use in accordance with the invention of a lacquer system. Sufficient adhesion, very good solvent resistance, high UV resistance, high resistance to hot and cold temperatures and to temperature changes, and also to humid heat, artificial hand perspiration, cosmetic base substances, and salt are already present after a short time. It is possible on the use in accordance with the invention of the lacquer system that the lacquer system hardens by means of irradiation of light in the near infrared range without any skin formation arising. The coated lenses can be directly delivered to a further process step due to the fast hardening. The resistance to solvents (ethanol, acetone/10 cycles with moistened cotton bud), UV radiation (96 h, 500 DIN ISO 9022-20-03-1), cold (16 h, -40° C. DIN ISO 9022-10-08-1), heat (16 h, 70° C./6 h, 85° DIN ISO 9022-11-05-1), rapid temperature changes (25° C./40° C. 5 cycles DIN ISO 9022-15-02-1), humid heat (21d 40° C. 95-98% rel. humidity DIN ISO 9022-12-04-1), artificial hand perspiration (7d DIN ISO 9022-86-02-1), cosmetic base substances (7d 9022-86-02-1), and a salt spray test (24 h DIN ISO 9022-4 Art. 40) is given by the use in accordance with the invention of a lacquer system and by the method in accordance with the invention on a lens in accordance with the invention. The lacquer system adheres so well to glass surfaces having a surface roughness Rₘₐₓ of 1 to 3 μm that a cross-cut test produces a value of GT=0. The cross-cut test is carried out in accordance with DIN EN ISO 2409:2013 The surface roughness is determined in accordance with DIN EN ISO 25178. A particularly good onflow of the lacquer can be achieved and the minimization of scattered light can additionally be particularly advantageously achieved with a surface roughness Rₘₐₓ in a range from 1 to 3 μm in combination with the use in accordance with the invention of a lacquer system.

Where light in the near infrared range (NIR) is named herein, light is meant that has a wavelength maximum in the range from 0.7 to 1.4 μm. The wavelength maximum of the NIR light is preferably in the range from 0.7 to 1.2 μm.

It must be noted that the first and second components can be separate from one another, but this does not necessarily have to be the case. This means that the components do not have to be present separate from one another, but can also be stored mixed with one another. If the components are stored mixed with one another, care must only be taken that no unwanted premature hardening of the lacquer system occurs, for example by temperatures that are too high or by irradiation with light. It can therefore be advantageous for reasons of a simpler storage and durability to store the components separately from one another.

Preferred further developments of the invention are set forth in the dependent claims and in the following. It is understood that the preferred further developments of the invention described in the following can be combined as desired with one another and in particular with the features of the claims. The feature combinations possible here are all to be considered preferred embodiments of the present invention. It is also understood that all the aspects named in the claims or in the following description relate both to the use in accordance with the invention and to the method in accordance with the invention even if only the use or the method are explicitly named. The same also applies accordingly to the lens in accordance with the invention.

Where which version is meant is not indicated for the standards mentioned here, the versions valid on Oct. 1, 2018 are meant.

The first and/or second component preferably contains/contain at least one black filler, in particular carbon black, as the filler. An edge lacquer coating can be produced on a lens by the use of a black filler that absorbs light in the visible range especially easily so that scattered light in the lens cylinder is reduced. It is particularly preferred if at least one black filler, in particular carbon black, is contained in the first component. Most preferably, black carbon is contained in the first component. In addition to the absorption of light in the visible range, black carbon can also increase the UV resistance of the lacquer system. The absorption of the light can be controlled via the amount of black filler, in particular black carbon, introduced; too high an amount of black component could have the result that only the surface of the lacquer is heated and no homogeneous hardening of the lacquer system takes place. It is preferred in this connection that the lacquer system has 3 to 18 mass portions of carbon black relative to 100 mass portions of the solid content of the lacquer system. It is even more preferred that the lacquer system has 4 to 16 mass portions of carbon black relative to 100 mass portions of the solid content of the lacquer system. 100 mass portions of the solid content of the lacquer system here relate to the mass of the lacquer system without dilution.

It is further preferred if the lacquer system does not contain either coal tar or coal tar pitch since coal tar and coal tar pitch are substance mixtures of different substances of which some are toxic, carcinogenic, or damaging to the environment. It is therefore particularly preferred if the lacquer system only contains carbon black as the black filler.

The first and/or second component preferably contains/contain at least one white filler, in particular silica and/or barium sulfate. Scattered light can be further reduced by the use of a white filler. It is particularly preferred if at least one white filler, in particular silica and/or barium sulfate, is contained in the first component. A combination of silica and barium sulfate is particularly preferably contained in the first component. Too high a portion of white filler could have the result that the light for hardening does not penetrate into lower layers. It is preferred in this connection that the lacquer system has 4 to 28 mass portions of white filler relative to 100 mass portions of the solid content of the lacquer system. It is even more preferred that the lacquer system has 6 to 20 mass portions of white filler relative to 100 mass portions of the solid content of the lacquer system. 100 mass portions of the solid content of the lacquer system here relate to the mass of the lacquer system without dilution.

At least one white filler and at least one black filler are preferably contained in the first component. A black and simultaneously matt lacquer edge coating can hereby be produced that is particularly advantageous with respect to the reduction of scattered light in a lens cylinder. As described above, the white filler is preferably silica and/or barium sulfate, very preferably silica and barium sulfate, and the black filler is preferably carbon black.

It is moreover preferred if the lacquer system has a gloss level after hardening at 60° of less than or equal to 12, even more preferably of less than or equal to 10. The gloss level test is determined in accordance with DIN EN ISO 2813:2015-02.

A lacquer system having such a gloss level supports the reduction of scattered light in a lens cylinder.

It is additionally preferred that the first component comprises an epoxy resin as the resin component. The epoxy resin is particularly preferably a halogen-free epoxy resin, i.e. an epoxy resin in which the halogen content is less than 5 wt. %, preferably less than 1 wt. %, relative to the weight of the epoxy resin. In addition to the epoxy resin, other resin components can also be contained in the first component, in particular acrylic resins. It can nevertheless be preferred only to use epoxy resin as resin components.

It is additionally preferred if the content of the at least one epoxy resin and/or of the at least one acrylic resin in the first component amounts to 25 to 50 wt. % relative to the total weight of the first component. It is additionally preferred if the content of the diluent amounts to 10 to 60 wt. % relative to the total weight of the first component. In addition, it is preferred if the content of filler amounts to 10 wt. % or more. The skilled person understands that the indicated preferred ranges for the content of epoxy resin and/or of at least one acrylic resin, for the content of the diluent, and for the content of filler can be combined with one another. It follows on from this that it is particularly preferred if the content of the at least one epoxy resin and/or of at least one acrylic resin in the first component of the lacquer system amounts to 25 to 50 wt. % relative to the total weight of the first component, if the content of the diluent amounts to 10 to 60 wt. % relative to the total weight of the first component, and if the content of filler amounts to 10 wt. % or more relative to the total weight of the first component. It is, however, clear that the combination of the indicated preferred range for the content of epoxy resin and/or acrylic resin with the preferred and more general ranges for the content of diluent and for the content of filler is also disclosed in combination. The same also applies analogously to the preferred ranges for the content of diluent and for the content of filler.

It is additionally preferred if no aromatic solvents are contained in the first component and if the diluent in the first component comprises at least one ester. A lacquer edge coating having the above-named desired properties can be realized with a diluent on an ester base. It is therefore particularly preferred that the diluent contains at least one ester.

In addition to the above-named preferred aspects, it is preferred that the first component comprises at least one polymer having acid groups. Such a polymer having acid groups can act as a dispersing agent and can stabilize a dispersion of solid components in the lacquer system such as fillers so that a uniform lacquer edge coating is produced.

To produce a uniform lacquer edge coating, a lacquer system is preferably used in the user in accordance with the invention whose dynamic viscosity amounts to 300 to 3000 mPa·s at 25° C. It is even more preferred if the dynamic viscosity of the lacquer system is in the range from 400 to 1500 mPa·s at 25° C. It is further preferred if the dynamic viscosity of the lacquer system is in the range from 500 to 1100 mPa·s at 25° C. The dynamic viscosity mentioned herein is measured in accordance with DIN EN ISO 2884-1:2006-09. A lacquer system having a dynamic viscosity as indicated above runs homogeneously and smoothly without any real edge thinning, i.e. the coating is not substantially thinner at edges than over a surface. A lacquer system having a dynamic viscosity in the named range can be applied homogeneously in thicknesses in the range from 1 μm to 30 μm in IT-6 quality in accordance with DIN ISO 256-1.

The lacquer system for a use in accordance with the invention can be applied to a lens by a brush, a sponge, or by spraying. A particularly suitable means for application is a wedge-shaped solvent-resistant sponge material. Hardening is possible both at room temperature and under heat. It has, however, been found advantageous in view of smaller process times and costs associated therewith if the lacquer system is hardened by irradiation with light from the near infrared range (NIR). It is in particular preferred in this connection that the coating on the edge of the lens is hardened by light from the near infrared range (NIR). A high energy input is achieved by irradiation with light from the near infrared range. This high energy input has the result that the crosslinking of the lacquer system takes place differently than with a conventional convection hardening (with short/long chains). Unlike convection heating, heating by NIR radiation has shorter chains, i.e. on average shorter chain segments are present between two crosslinking points than with convection hardening. As a result, the lacquer stability is improved with respect to solvents, e.g. acetone, by the NIR process.

It is preferred in the method in accordance with the invention that the irradiation in step (B) is carried out for a time period of less than 5 minutes. The irradiation in step (B) can be carried out very fast so that a sufficient hardening of the lacquer system and the above-named properties are already reached after a very short time, for example 1 second. In principle, an irradiation over a longer time period than 5 minutes is also possible, but it is not economically sensible and the risk is increased of heating the lens too much so that damage can occur. The risk is additionally increased that an overhardening and burning of the lacquer occurs, whereby the properties of the hardened lacquer system deteriorate. In this connection, an irradiation of less than 3 minutes is more preferred and of less than 2 minutes is even more preferred, and of less than 1 minute is most preferred. An irradiation of 1 second or longer is preferred, of 5 seconds or longer is more preferred, and of 15 seconds or longer is even further preferred to ensure a sufficient hardening of the lacquer system. It must be noted that said lower limits of 1 second, 5 seconds, and 15 seconds are to be considered as disclosed in any desired combination with said upper limits of 5 minutes, 3 minutes, 2 minutes, and 1 minute.

A hardening process that ramps up the powers of the NIR radiators has proved to be particularly advantageous, in particular with thermally sensitive substrates such as the glass S-FPL51. The use of very “sensitive” optical glasses has become standard in the optical industry in the meantime and makes a lacquering process by hardening by NIR more difficult (strains/chemical resistance values, glass hardness, thermal expansion coefficient, thermal conductivity, etc.). In such a hardening process, irradiation first takes place at a power of the NIR radiator that does not correspond to the maximum power, for example 70% or less of the maximum power. Irradiation subsequently takes place at a higher power of the NIR radiator than before. The increase in the power of the NIR radiation can either take place continuously or a first irradiation step at a constant power of the NIR radiator can take place first followed by at least one further irradiation step at a higher power of the NIR radiator. There can be a break between two consecutive irradiation steps during which no irradiation is performed so that the irradiation takes place in a pulsed manner. Such a pulsed irradiation can be advantageous so that the substrate, for example a heat-sensitive glass, is not heated excessively and also not excessively fast, whereby the occurrence of high strains in the glass can be avoided. The duration of the respective irradiation step or the pulse duration can here, for example, be in the range from 1 to 5 seconds.

On a pulsed irradiation, the irradiation in a first irradiation step can also be the same as in a subsequent irradiation step. A break of 1 to 5 seconds is preferably provided between two consecutive irradiation steps.

It is preferred if the lens is irradiated with a power per surface unit of 250 to 600 k/m² in method step (B).

It is further preferred that the lacquer system is applied with a layer thickness of 1 to 50 μm in step (A). An application of a layer thickness of 1 to 50 μm enables a fast hardening and simultaneously a homogeneous and opaque lacquer edge coating on the lens. It is particularly preferred in this connection if the layer thickness amounts to 2 to 25 μm, even more preferably 2 to 15 μm.

In the method in accordance with the invention, it is additionally preferred to already carry out a layer thickness measurement of the lacquer system before the hardening. A homogeneous and opaque lacquer edge coating of the lens can hereby be ensured and the number of rejects produced can be reduced. The measurement of the layer thickness can, for example, take place by a laser-assisted measurement system using infrared sensors. The layer thickness measurement preferably takes place by means of laser photothermal radiometry. A possibility for measuring the layer thickness is disclosed, for example, in international patent application WO 2015/001210 A1 whose content is herewith included by reference.

It is further preferred that the irradiation is carried out in step (B) by at least one NIR radiator that has light at a wavelength maximum in the range from 0.7 to 1.4 μm. The wavelength maximum is more preferably in the range from 0.7 μm to 1.2 μm; the wavelength maximum is most preferably in the range from 0.85 μm to 0.95 μm.

To avoid an overheating of the lens, it is preferred that the lens is cooled during the irradiation with light at a wavelength in the range from 0.7 μm to 1.4 μm. It can be prevented by the use of a cooling that strains occur in the lens, whereby the coating of more temperature sensitive lenses is also possible. The cooling preferably takes place by compressed air, for example by the use of a fan nozzle, whereby a co-called cooling curtain is formed. It is moreover preferred in this connection if the temperature of the lens is measured, e.g. via one or more pyrometers, at least during the irradiation and optionally also only during the irradiation. An example for pyrometers includes thermal imaging cameras, but other pyrometers can also be used. The temperature measurement can be used to determine that the coating process is running as planned. The information on the temperature of the lens can, however, also be used to control the power of the NIR radiators, the cooling, or the rotation of the lens.

A uniform hardening of the lacquer can be achieved in that the lens rotates relative to a light source that emits light at a wavelength in the range from 0.7 μm to 1.4 μm during the carrying out of step (B). It is particularly preferred for the lens to rotate about an axis of rotation. A rotational speed of 150-350 r.p.m., particularly preferably of 200-250 r.p.m., has proved to be a preferred rotational speed during step (B). It is additionally preferred that the lens also rotates in step (A) to simplify a uniform application of the lacquer system. The rotational speed in step (A) preferably amounts to 200 to 400 r.p.m., particularly preferably to 300-350 r.p.m.

The lens is composed of a transparent material, preferably of glass.

The invention will be described in the following by way of example with reference to the enclosed Figures. There are shown, schematically in each case:

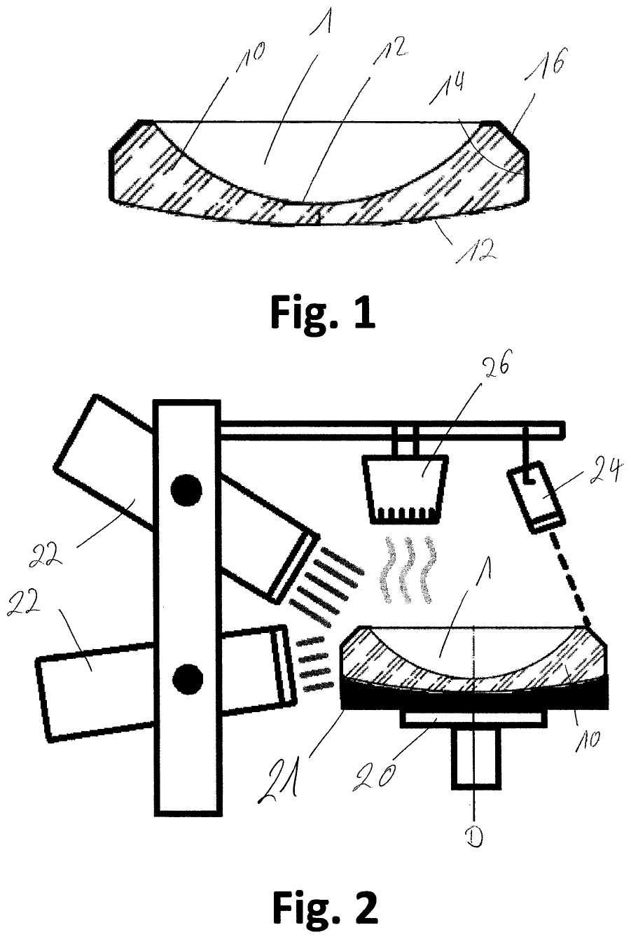

FIG. 1 a cross-section through a lens in accordance with the invention; and

FIG. 2 an apparatus for carrying out the method in accordance with the invention.

A lens 1 is schematically shown in FIG. 1 whose transparent body 10 has arched surfaces 12 that are bounded by a border or edge 14. A lacquer edge coating 16 is applied to the edge 14. The lacquer edge coating 16 is able to minimize scattered light at the edge of the lens 1.

An apparatus for carrying out the method in accordance with the invention for coating the edge 14 is shown schematically in FIG. 2. The apparatus shown in FIG. 2 first has a holder 20 for the lens 1 shown in FIG. 1. The holder 20 is rotatably supported about an axis D and is produced from metal, for example. An adapter 21 that has a surface that is arched to match a surface is provided on the holder 20. This adapter can, for example, be produced from a plastic such as PEEK. The apparatus furthermore has means to apply a lacquer system to produce the lacquer edge coating 16. These means are, however, not shown in FIG. 2. Furthermore, in the apparatus shown in FIG. 2, two NIR radiators 22 are provided that emit NIR radiation in the direction of the edge 14 of the lens 1 to harden the applied lacquer system while the lens is rotated about the axis D. The temperature of the lenses 1 during the irradiation by the NIR radiators 22 can be monitored via a pyrometer 24. The cooling apparatus 26 can, where necessary, cool the body 10 of the lens 1 in that compressed air is, for example, blown onto it.

The invention will be explained in more detail in the following with reference to examples that are, however, not to be understood as restrictive.

A lacquer system suitable for a use in accordance with the invention can comprise a composition such as is indicated in the following Table 1.

The components shown in Table 1 were mixed in the indicated amounts and subsequently applied to an edge of a lens composed of glass having a surface roughness Rₘₐₓ of 1 to 3 μm. Hardening took place by irradiation with NIR light at a wavelength maximum of 0.9 μm and at an irradiation power of 450 kW/m².

The resistance to solvents (ethanol, acetone/10 cycles with moistened cotton bud), UV radiation (96 h, 500 DIN ISO 9022-20-03-1), cold (16h, −40° C. DIN ISO 9022-10-08-1), heat (16 h, 70° C./6 h, 85° DIN ISO 9022-11-05-1), rapid temperature change (25° C./40° C. 5 cycles DIN ISO 9022-15-02-1), humid heat (21d 40° C. 95-98% rel. humidity DIN ISO 9022-12-04-1), artificial hand perspiration (7d DIN ISO 9022-86-02-1), cosmetic base substances (7d 9022-86-02-1), and a salt spray test (24h DIN ISO 9022-4 Art. 40) was examined after hardening and was satisfied by the lacquer systems of Examples 1 to 4.

In principle, all the lacquer systems indicated in the examples are suitable to manufacture a uniform lacquer border or edge coating. However, the resistance to solvents,

UV radiation, cold, heat, rapid temperature change, humid heat, artificial hand perspiration, cosmetic base substances, and a salt spray test are most advantageously pronounced for the lacquer system in accordance with Example 1.

An exemplary irradiation plan with which temperature sensitive glasses can be coated particularly well is shown in table form in the following.

| Radiator on | Radiator off | Power |
|---|---|---|
| 1 s | 3 s | 50% |
| 1 s | 3 s | 70% |
| 3 s | 3 s | 90% |
| 3 s | 3 s | 90% |
| 3 s | 3 s | 90% |

In the above representation of the irradiation plan, a power of 100% corresponds to an irradiation power of 450 kW/m² (maximum power of the NIR radiator). An irradiation at 50% of the maximum power of the NIR radiator is first carried out for 1 second before the irradiation is paused for 3 seconds. Irradiation is subsequently carried out at 70% of the maximum power of the NIR radiator for 1 second before the irradiation is again paused for 3 seconds. An irradiation at 90% of the maximum power of the NIR radiator is then carried out for 3 seconds, with the irradiation being paused for 3 seconds after every irradiation step.

TABLE 1

| Component | Example 1 | Example 2 | Example 3 | Example 4 |
|---|---|---|---|---|
| First component, | 25-36% epoxy resin *1 | 20-40% MMA resin *6 | 45-50% acrylic resin *10 | 17-36% epoxy resin *1 |
| Amounts in wt. % | | | | |
| | 1-20% propyl methyl | 15-35% vinyl acetate *7 | 10-25% propylene glycol | 1-20% propyl methyl |
| | acetate | | diacetate | acetate |
| | 10-30% ethoxy propyl | 15-25% xylol | 5-15% barium sulfate *2 | 10-30% butyl glycol |
| | acetate | | | acetate |
| | 5-15% barium sulfate *2 | 10-20% methyl isobutyl | 5-10% black carbon *3 | 5-15% barium sulfate *2 |
| | | ketone | | |
| | 5-10% black carbon *3 | 5% *8 plasticizer | 1-5% silica *11 | 5-10% black carbon *3 |
| | 3-6% silica *4 | 2-5% black carbon *3 | 2.5% (3-glycidyloxypropyl) | 3-6% silica *4 |
| | | | trimethoxy silane | |
| | 2% dispersing agent *5 | 1.5% dispersing agent *5 | 1.5% dispersing agent *5 | 2% dispersing agent *5 |
| | | 1-2% superplasticizer *9 | 1-2% superplasticizer *9 | |
| | | 0.05% dibutyltin laurate | 0.05% dibutyltin laurate | |
| Second component | Aliphatic isocyanate *12 | Aromatic isocyanate *14 | Aliphatic isocyanate *12 | Aminic hardener *13 |
| | or aminic hardener *13 | | | |
| First component: | 100:10 | 100:20 | 100:10 | 100:20 |
| Second component | | | | |

*1 to *14 are explained in more detail in the following
Explanation for *1 to *14 in Table 1:
*1 Bisphenol A based epoxy resin Araldit GT 7004, available from Jubail Chemical Industries Company
*2 Blanc Fixe N, available from Solvay S.A.
*3 Color black fw 200, available from Orion Engineered Carbons
*4 Aerosil 200, available from Evonik
*5 Disperbyk 180, available from BYK-CHEMIE GMBH
*6 Degalan 560, available from Evonik
*7 Vinnapas 5010 N, available from Wacker Chemie AG
*8 1,2-cyclohexane dicarboxylic acid diisononyl ester
*9 Polyether modified polysiloxane, Borchi Gol OL 17, available from Borchers GmbH
*10 Setalux 1122, available from Allnex Netherlands B.V.
*11 Aerosil R972, available from Evonik
*12 Desmodur N75, available from Covestro
*13 Versamin M1, available from Gabriel Performance Products, LLC
*14 Desmodur E17, available from Covestro

### REFERENCE NUMERALS

1 lens

2 body

12 arched surface

14 edge

16 lacquer edge coating

20 holder

21 adapter

22 NIR radiator

24 pyrometer

26 cooling apparatus

D axis

1. Use of a lacquer system for producing a lacquer edge coating on an edge of a lens,
wherein the lacquer system comprises: at least one first component and one second component and the first component and second component configured to be hardened by irradiation with light of a wavelength in the range from 0.7 to 1.4 μm;
wherein the first component comprises at least one resin component selected from the group comprising epoxy resin, acrylic resin, and mixtures thereof, at least one diluent in the form of an organic solvent, and at least one or more fillers;
wherein the content of the at least one epoxy resin and/or at least one acrylic resin in the first component amounts to 20 to 65 wt. % relative to the total weight of the first component;
the content of the diluent amounts to 5 to 70 wt. % relative to the total weight of the first component; and
the content of filler amounts to 2 wt. % or more relative to the total weight of the first component; and
wherein the second component comprises at least one crosslinking agent that is selected from the group comprising aliphatic isocyanates, aromatic isocyanates, compounds with amino groups, and mixtures thereof

2. Use in accordance with claim 1,
wherein either the first and/or second component further comprises least one black filler.

3. Use in accordance with claim 1,
wherein the first and/or second component comprises/comprise at least one white filler, in particular silica and/or barium sulfate.

4. Use in accordance with claim 1,
wherein the first component comprises an epoxy resin as the resin component.

5. Use in accordance with claim 1,
wherein no aromatic solvents are contained in the first component and the diluent in the first component comprises at least one ester.

6. Use in accordance with claim 1,
wherein the first component comprises at least one polymer having acid groups.

7. Use in accordance with claim 1,
wherein a dynamic viscosity of the lacquer system amounts to 300 to 3000 mPa·s at 25° C.

8. A method of coating an edge of a lens, comprising
applying a lacquer system to an edge of the lens to be coated,
wherein the lacquer system is a lacquer system for use in accordance with claim 1; and
hardening the lacquer system by irradiation with light at a wavelength in the range from 0.7 μm to 1.4 μm.

9. A method in accordance with claim 8,
comprising irradiating the for a time period of less than 30 minutes.

10. A method in accordance with claim 8,
wherein the applying a lacquer system is applying with a layer thickness of 1 to 50 μm.

11. A method in accordance with claim 8,
wherein a layer thickness measurement of the lacquer system takes place before said hardening.

12. A method in accordance with claim 8,
wherein the irradiating is carried out by at least one NIR radiator that has light at a wavelength maximum in the range from 0.7 to 1.4 μm.

13. A method in accordance with claim 8,
further comprising cooling the lens, wherein the lens is cooled during the irradiation with light at a wavelength in the range from 0.7 to 1.4 μm.

14. A method in accordance with claim 8,
wherein the lens is rotated relative to a light source that emits light at a wavelength in the range from 0.7 μm to 1.4 μm.

15. A method in accordance with claim 8,
wherein the irradiation is carried out in a pulsed manner.

16. A lens comprising:
an edge lacquer coating available by a use of a lacquer system in accordance with claim 1.

17. Use in accordance with claim 2, wherein the at least one black filler is carbon black.
